(19) United States
(12) Patent Application Publication
(10) Pub. No.: US 2026/0340902 A1
(43) Pub. Date: Oct. 29, 2026

(54) METHOD AND SYSTEM FOR AI-GENERATED EVALUATION OF EMOTIVE STATE AND RESPONSIVE MEDIA GENERATION

(71) Applicant: Jake Bergstrom, West Valley, UT (US)

(72) Inventor: Jake Bergstrom, West Valley, UT (US)

(21) Appl. No.: 19/566,857

(22) Filed: Mar. 13, 2026

Related U.S. Application Data
(60) Provisional application No. 63/796,221, filed on Apr. 28, 2025.

(51) Int. Cl. G06T 11/60; G06F 3/01; G06F 11/34; G06N 3/092; G06V 40/16; G10H 1/00; G10L 17/00

(52) U.S. Cl. CPC G06T 11/60; G06F 3/013; G06F 11/3438; G06N 3/092; G06V 40/168; G10H 1/0025; G10L 17/00

(57) ABSTRACT

A computer-implemented system and method for evaluating an emotional state of a human subject and generating responsive digital media using artificial intelligence. Multimedia input associated with a subject, including image, video, audio, text, or behavioral interaction data, is received and processed to extract biometric and expressive features. Extracted features may include facial landmark geometry, vocal acoustic characteristics, lexical sentiment indicators, and behavioral biometrics. The extracted data is compared with stored reference specimens, including subject-specific neutral baseline specimens and historical emotive datasets. One or more machine learning models determine an emotional state and associated intensity value and generate a multidimensional emotional vector. A generative artificial intelligence engine produces responsive digital media, including music, images, video, or text, based on the determined emotional state. Subsequent biometric measurements captured after presentation of the generated media are analyzed to modify media generation parameters, thereby forming an adaptive feedback loop that improves personalization of emotional modulation for the subject.

### FIELD OF THE INVENTION

This invention relates to a method and system for evaluating human emotion using artificial intelligence and in particular a method of creating media responsive to the evaluated emotion, including music, video and images.

### BACKGROUND

### Description of the Related Art

In general, a person's emotions, such as sadness, anger, love, joy, apathy, hate, can be recognized by other humans in facial expressions, countenance, voice patterns, and through real-time textual analysis.

Quite often, individuals experiencing strong emotional feeling seek entertainment and media which reaffirms or negates these feelings. For instance, an individual experiencing anger may listen to angry music as a way of reducing or assuaging or aggravating angry feelings without taking action upon them.

Facial expressions reflect characteristic patterns of thoughts, intelligence, feelings, and behaviors which are outgrowths of the mind. These outgrowths can be noticed by individuals and may be dynamic functions of changing environments, stimuli, genetics, and conditioning, and may change through a single day with changing times and conditions.

Humans express emotion through multimodal channels including facial micro-expressions, macro-expressions, speech cadence, lexical selection, body posture, gaze direction, interaction timing, and behavioral biometrics. While humans intuitively interpret such signals, automated systems have historically lacked reliable, individualized, and adaptive emotional interpretation capabilities.

Existing emotion-recognition systems primarily focus on classification tasks (e.g., labeling a face as “happy” or “sad”). These systems typically output static labels and do not adaptively generate personalized media responses designed to influence the detected emotional state.

Similarly, media recommendation systems operate using preference history, demographic information, or collaborative filtering techniques, but do not dynamically generate novel media content tailored to a subject's real-time emotional condition.

There remains a need for an integrated, closed-loop artificial intelligence system capable of: evaluating emotional state using multimodal inputs, comparing such inputs to personalized control specimens, categorizing emotional intensity, generating original AI-created media content designed to either assuage or reinforce the emotional state, and (e) iteratively improving future output using biometric response feedback.

The present invention addresses these unmet needs through a predictive, adaptive AI system for emotion evaluation and responsive media generation. There is a need in the art for an AI-driven methodology of evaluating these emotions and generating media meant to assuage them. There is a need for a holistic system for predictive application of AI-generated media, including music, to treat human emotional states, such as anger and depression. Predictive use of AI-generated media is unknown in the art. It is an object of the present invention to provide a system and method which meets these unmet needs in the art.

### SUMMARY

From the foregoing discussion, it should be apparent that a need exists for a method and system for AI-generated evaluation of emotive state and responsive media generation. A method for evaluating an emotive state and producing responsive, AI-generated media, is provided, the method comprising: a computer-implemented method for adaptive emotional modulation, the method comprising: receiving, at one or more processors, multimedia input associated with a human subject; extracting biometric feature data from the multimedia input; comparing the biometric feature data to stored reference specimens in computer-readable memory; determining, using at least one machine learning model, an emotional state of the human subject and an associated intensity value; categorizing the emotional state as positive or negative; generating, using a generative artificial intelligence engine, original digital media responsive to the emotional state; presenting the generated digital media to the human subject; capturing updated biometric feature data after presentation of the generated digital media; and modifying one or more media generation parameters based on the updated biometric feature data.

The media may comprise one or more of text, audio, an image, and video. The multimedia input may comprise at least one of image data, video data, audio data, or text data.

In some embodiments, the extracting biometric feature data comprises identifying facial landmarks and calculating geometric distances between facial features.

The extracting biometric feature data may comprise analyzing vocal pitch, cadence, and harmonic content. The extracting biometric feature data may comprise performing lexical sentiment analysis on textual input.

The method step of determining the emotional state may further comprise generating a multidimensional emotional vector comprising polarity and intensity components.

The stored reference specimens may comprise neutral baseline specimens of the same human subject.

The stored reference specimens may comprise subject-specific emotive-state exemplars.

The stored reference specimens may comprise population-based emotional datasets. The step of generating original digital media comprises generating an original musical composition.

The step of generating the original musical composition may comprises adjusting tempo based on the intensity value.

The step of generating the original musical composition comprises selecting harmonic structure based on the categorized emotional state.

The step of generating original digital media comprises generating an image having a color palette selected based on the emotional state.

The step of capturing updated biometric feature data may comprise re-evaluating facial measurements after presentation of the generated digital media.

In alternate embodiments, the method of claim 1, wherein modifying media generation parameters comprises applying reinforcement learning based on measured emotional response.

The method may further comprise storing emotional-response correlation data in persistent storage. The step of extracting biometric feature data further comprises analyzing behavioral biometrics including keystroke latency or cursor movement patterns.

A method for evaluating an emotive state and producing responsive, AI-generated media is provided, the method comprising: recording media of a human subject; uploading the recorded media via a WAN to a technology provider; processing the media to evaluate an emotive state of the subject; comparing the media to one or more specimens in computer-readable memory; determining one or more feelings being experienced by a subject; categorizing the feelings as one of negative and positive; generating output media adapted to assuage negative feelings; recording specimens in historical, computer-readable memory; downloading the output media to a DPD; and recording the output media in computer-readable memory.

The media may comprise one or more of text, audio, an image, and video.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a diagram exemplifying a comparative analysis algorithm configured to evaluate an emotive state and produce music in response in accordance with the present invention;

FIG. 2A is a diagram exemplifying a comparative analysis algorithm configured to evaluate an emotive state and produce media in response in accordance with the present invention;

FIG. 2B is a diagram exemplifying a comparative analysis algorithm configured to evaluate an emotive state from behavior biometrics and produce media in response in accordance with the present invention;

FIG. 2C is a diagram exemplifying a comparative analysis algorithm configured to evaluate an emotive state from behavior biometrics and produce media in response in accordance with the present invention;

FIG. 2D illustrates an exemplary algorithm for calculating an anxiety score in accordance with the present invention;

FIG. 2E illustrates an exemplary algorithm for calculating an anger score in accordance with the present invention;

FIG. 3 is an illustrative browser displaying an exemplary interface adapted to facilitate analysis of an emotional state and rendering media exclusively associated with the individual and emotional state in accordance with the present invention;

FIG. 4 is a data-entity diagram of a method of generated emotive AI-media in accordance with the present invention;

FIG. 5 is a data-entity diagram of a method of generating emotive AI-media in accordance with the present invention;

FIG. 6 is a block diagram illustrating one embodiment of a system 600 configured to evaluate an emotive state of a subject 102 and generate responsive AI media 106 in accordance with the present invention;

FIG. 7 is a flow chart illustrating one embodiment of a method and system for AI-generated evaluation of emotive state and responsive media generation in accordance with the present invention; and

FIG. 8 is a data entity diagram illustrating one embodiment of a method and system for AI-generated evaluation of emotive state and responsive media generation in accordance with the present invention; and

FIG. 9 is a diagram illustrating the structure of an multidimensional emotional vector in accordance with the present invention.

Like reference numerals refer to like parts throughout the various views of the drawings. Reference numerals having a common numeric prefix but ending with a letter indicate multiple instances of the same part.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention provides a computer-implemented method and system for adaptive emotional modulation of a human subject. As described in the claims and illustrated throughout the drawings, the system operates as a closed-loop architecture in which multimedia input from the subject is received and processed to extract biometric feature data, an emotional state is determined using machine learning, responsive digital media is generated and presented, and the subject's biometric response to that media is captured and used to refine future media generation parameters. Each stage of this pipeline is described in detail below with reference to the corresponding drawing figures.

As used throughout this specification, the term “multimedia input” may refer to any one or more of video data, audio data, photographic image data, and text data associated with the human subject 102. The term “biometric feature data” encompasses facial landmark measurements, vocal acoustic features, lexical sentiment indicators, and behavioral interaction metrics derived from such multimedia input. The term ‘stored reference specimens’ refers to previously recorded biometric data maintained in computer-readable memory, including neutral baseline specimens, subject-specific emotive-state exemplars, and population-based emotional datasets. These terms are used consistently throughout the claims and the descriptions of each drawing figure below.

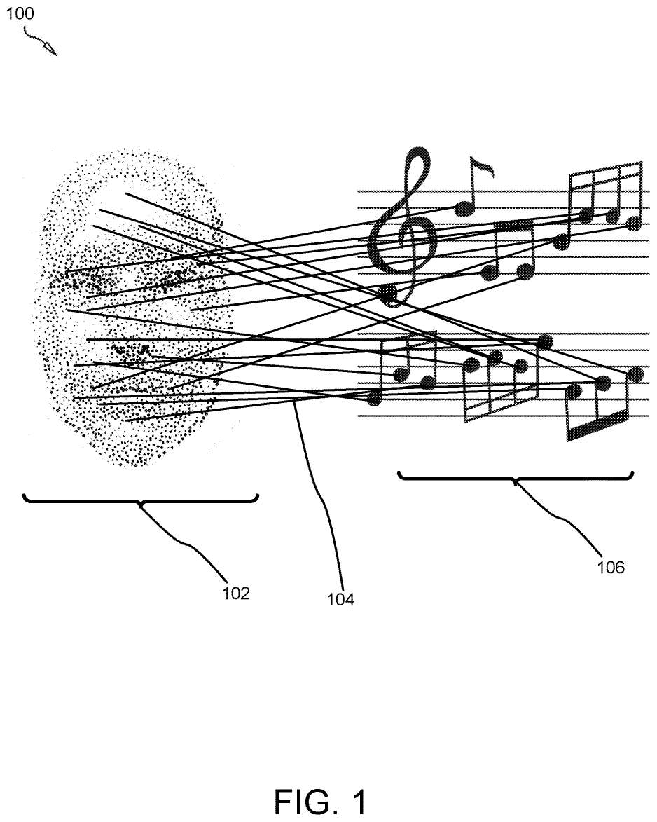

FIG. 1 is a diagram exemplifying a comparative analysis algorithm 100 configured to evaluate an emotive state and produce music in response in accordance with the present invention.

In various embodiments, photographs and/or video are recorded of a human subject. Different physical characteristics of the subject are focused on in the evaluation process. In particular, the video of the face is analyzed, but also video of arms, hands and body position. In the case of video, the video may be parsed into a plurality of still shots or images.

As shown in FIG. 1, a subject 102 (i.e., user 102) provides media 202, including image, video, audio, or text. The measuring module extracts facial data points 104 including geometric distances, curvature analysis, angular measurements, symmetry ratios, and micro-expression timing.

In video embodiments, frame-by-frame temporal analysis may be performed to detect one or more of: blink frequency, saccadic eye motion, micro-tremors, jaw tension, lip compression, and eyebrow elevation dynamics.

Audio input may be processed for metrics such as, including one or more of: pitch variance, harmonic richness, vocal strain, speech rate, pause frequency, lexical sentiment, and the like.

In some cases, audio is recorded with the video and in other embodiments, the audio may be recorded independently of the video.

The video, audio and/or images (i.e. “media”) is saved in computer-readable memory and in some cases in an RDBMS 422.

The system 100 receives media 202 from a subject 102, including photographs, video, audio, or text. The measuring module extracts a plurality of data points 104 from the media, which serve as the biometric feature data recited in claim 1. These data points 104 include, but are not limited to, geometric distances between facial landmarks, curvature analyses of facial features, angular measurements, symmetry ratios, and micro-expression timing signals.

The subject 102 may record video of himself or herself describing his emotive state or narrating a history of life events. The multimedia file 202 may be saved into computer-readable memory in the smart phone in any format commonly known to those of skill in the art, including MPEG codecs or other codecs known to those of skill in the art, which may interleave packetized audio and video bitstreams, or elementary streams, into program streams created using standardized protocols to facilitate data transmission over one or more communication channel(s) on a network with an AI-engine. Audio bitstreams are encoded to the MPEG standards in what has became known as the MPEG-1 Audio Layer 3 format, or MP3 format. MP3 codecs compress audio streams by reducing the accuracy of portions of the original audio stream considered to be beyond the auditory resolution ability of the average human ear.

The media 202 may be comprised of layers of multiplexed information associated with, and forming, the compressed media (e.g. acoustic information is layered onto video information). In later versions of the MPEG standards, textual information, such as closed captions and even tactile information (e.g. Braille), are layered upon acoustic/audiographic and video information.

The media, including photographs of the subject's face, are analyzed against one or more control specimens 212 of the subject previously stored in computer-readable memory for comparative analysis. These control specimens 212 show the subject in a neutral emotive affect and may be used for comparison. In other embodiments, the control specimens of other individuals are used for comparison. In still further embodiments, the control specimens of the subject 102 in emotively-excited states are used, such as angry, happy, sad, and the like.

By way of example, certain measurements 104 in the subject's 102 face may be used by artificial intelligence (AI) in performing the comparative analysis 240. For instance, the distance between a data point above the center of an eye and the corner of a mouth may constitute a measurement 104 which is used in evaluating an emotive state. For instance, the mouth of the subject 102, when curved upwardly, is closely in proximity to the center of the eye in a happy emotive state than when the mouth is turned down in a sad emotive state.

Music (or video or images) are generated using AI calculated to assuage negative feelings, or reinforce positive feelings. Feelings may be pre-categorized as negative or positive feelings. The AI engine may record media of the subject 102 while listening to music 106 or viewing an output from the AI-generated content to gauge whether the output media 106 is eliciting a proper emotive response. Historical data relating to those outputs 106 which have generated the emotive responses or nonresponses are recorded for use in improving future outputs 106 exclusively associated with the subject 102.

In various embodiments, the technology provider maintaining a server 422 stores specimens 212 in computer-readable memory which demonstrates facial expressions in various emotive states, including happy, joyful, anxious, sad, excited, weeping, surprised, and the like. These emotive states may be determined by measuring distances between ears and the corners of the mouth; the shape of the mouth including whether a top edge of the mouth is linear, arcuate, concave or convex; the shape of eyebrows, including whether eyebrows are pulled up in arcuate fashion in the middle or forced downward toward interior edges; whether teeth showing; and whether eyes are glossy or tear-filled. In various embodiments, video comprises a plurality of still frames (i.e., images) is analyzed.

With continued reference to FIG. 1, the extracted data points 104 are processed through the comparative analysis algorithm 100, which compares the data to stored reference specimens 212 maintained in computer-readable memory. The reference specimens 212 may comprise neutral baseline specimens of the subject 102, subject-specific emotive-state exemplars, or population-based emotional datasets, and embodiments described herein. As shown by the data flow in FIG. 1, the output of this comparative analysis is used to drive generation of responsive media 106, in this embodiment an original musical composition, through the AI engine 414.

The bidirectional data flow illustrated in FIG. 1 between the subject 102, data points 104, and output media 106 is representative of the closed-loop feedback architecture. After the output media 106 is presented to the subject 102, updated biometric feature data is captured through continued observation of the subject, and one or more media generation parameters are modified based on that updated data. In music-generation embodiments, these parameters include but are not limited to tempo, harmonic structure, rhythmic density, tonal center, and instrument timbre.

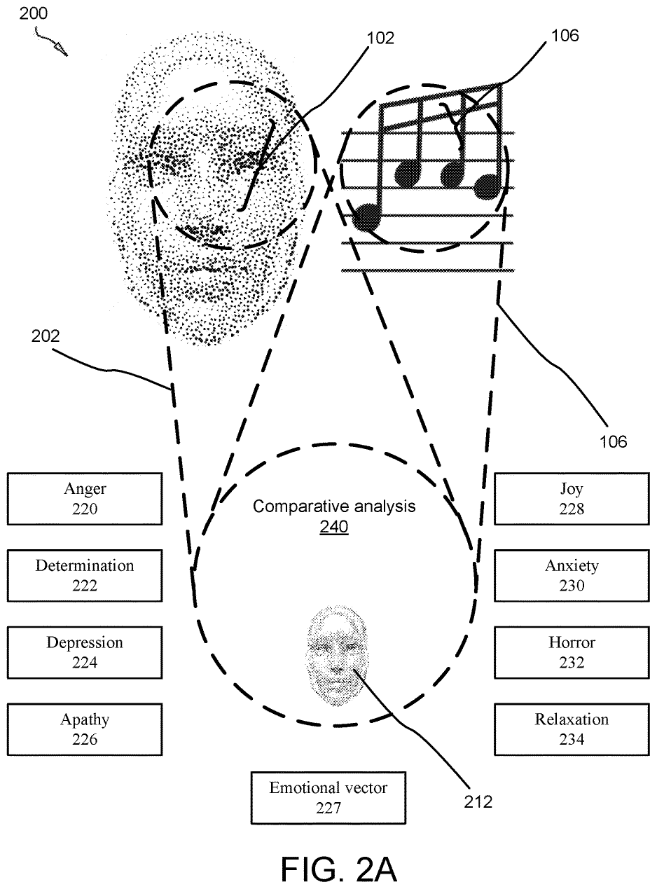

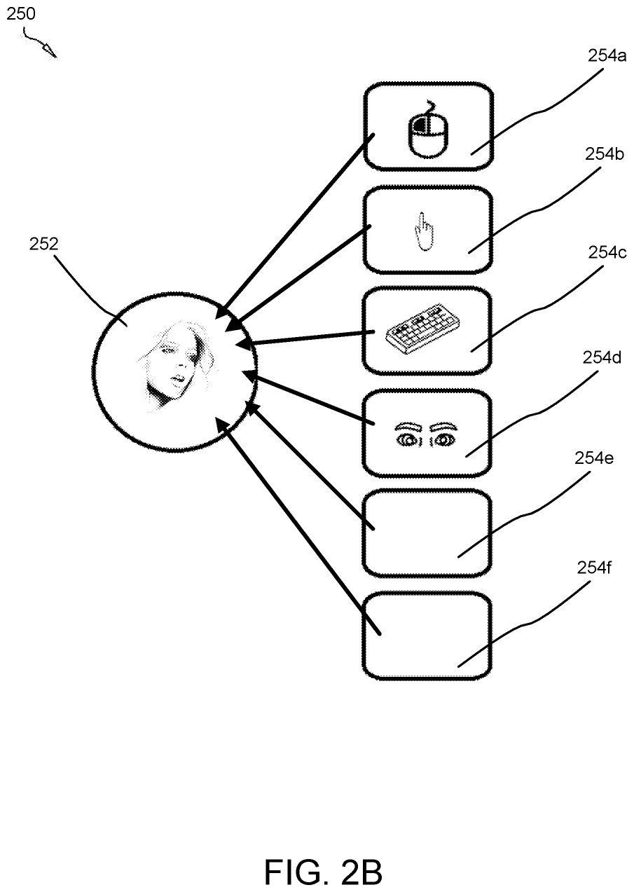

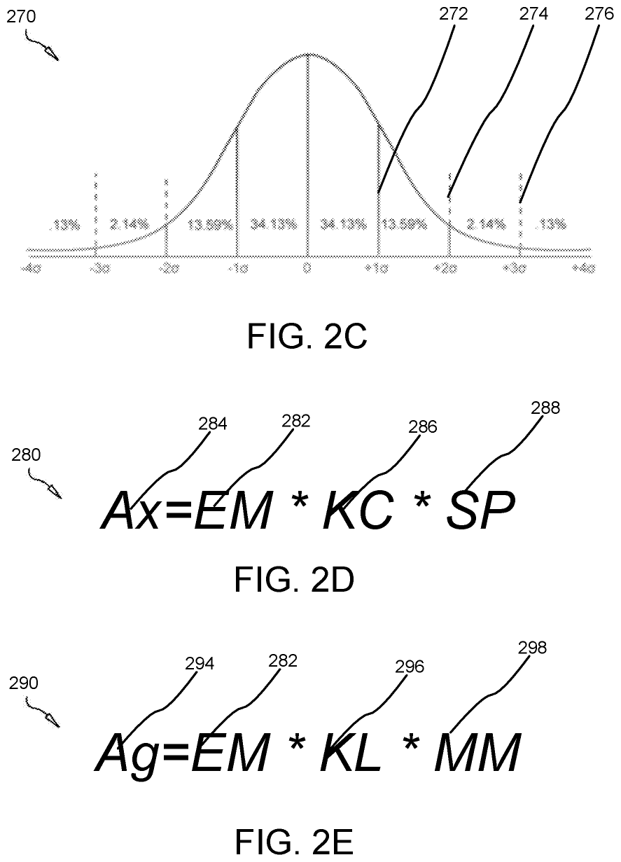

FIG. 2A is a diagram exemplifying a comparative analysis algorithm 200 configured to evaluate an emotive state and produce media in response in accordance with the present invention.

In various embodiments, the feelings 220-234 evaluated or ascertained by the media 202 are categorized into positive or negative feelings. Negative feelings may include anger 220, depression 224, horror 232, apathy 226, disgust, or anxiety 230. Positive feelings may include joy 228, relation 234, and determination 222.

The system 200 does not produce a single binary classification but rather evaluates the subject's emotional condition across multiple dimensions simultaneously. This supports the multidimensional emotional vector, wherein the vector represents polarity and intensity of one or more co-occurring emotional states.

As illustrated in FIG. 2A, the comparative module 240 compares extracted features to neutral specimens 212, subject-specific historical emotive specimens, and/or generalized population emotive models. Each detected emotion may be assigned a probability score, an intensity scalar value, and a temporal persistence metric. The system may produce a multidimensional emotion vector from these assigned values.

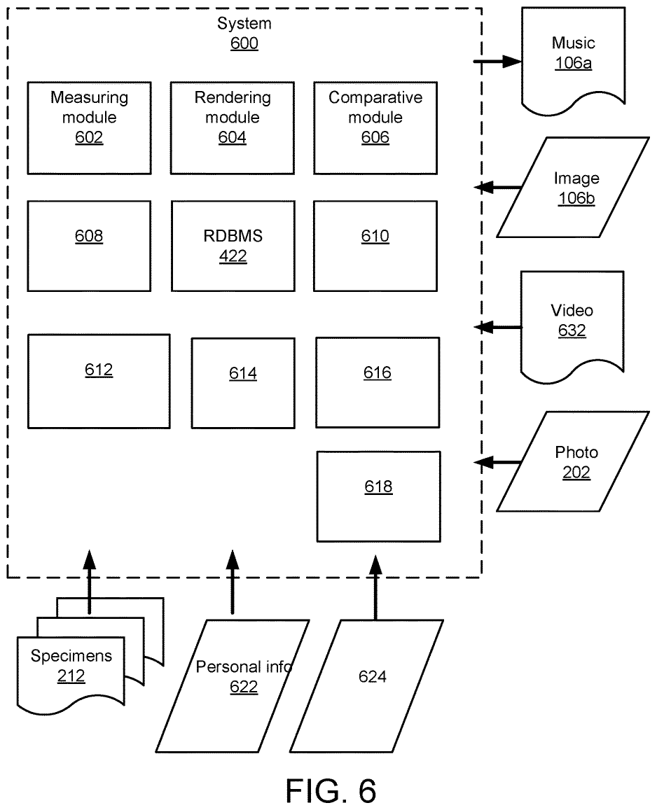

For each detected emotional state in the set 220-234, the comparative analysis module 240 assigns a probability score, an intensity scalar value, and a temporal persistence metric. The combination of these three components for each detected emotion forms the multidimensional emotional vector 227. This vector encodes not merely what emotion is present but how strongly it is present and how long it has persisted, providing the generative AI engine with a rich, structured input from which responsive media 106 can be precisely calibrated. The rendering module 604 then maps this vector to specific media generation parameters as described in connection with FIGS. 2D, 2E, and 6 below.

FIG. 2B is a diagram 250 exemplifying a comparative analysis algorithm configured to evaluate an emotive state from behavior biometrics and produce media in response in accordance with the present invention.

In various embodiments, a behavior profile 252 is created through behavior metrics derived from user interactions with the technology provider, including mouse clicking behavior 254a, mouse/cursory movement behavior 254b, keyboard input 254c including a length of time between key clicks, eye movement 254d, speech patterns 254e, and/or mouth movement 254f.

A behavioral biometrics module 610 (further described below) may be configured to analyzes a user's 102 physical and cognitive behavior as manifest through real time interactions with the technology provider identify an emotive state of the user.

The behavioral biometrics module 610 may be configured to use machine learning to analyze patterns in human activity and detect whether someone really is who they claim to be and what emotive state said user is experiencing when they interact online and whether the activity is driven by a human or part of an automated attack.

As illustrated, the comparative module 240 compares extracted features to: neutral specimens 212, subject-specific historical emotive specimens, and/or generalized population emotive models.

Each detected emotion (e.g., anger 220, depression 224, joy 228, anxiety 230, relaxation 234) may be assigned: a probability score, an intensity scalar value, and a temporal persistence metric.

The system may produce a multi-dimensional emotion vector.

Upon determining a predominant emotional vector, a rendering module 604 generates media 106. In music embodiments, tempo, key signature, harmonic complexity, dissonance level, rhythmic density, and instrument timbre may be modulated in response to emotional intensity. For example: high anger intensity may indicate increased tempo, distorted timbre, and minor tonal center; depression may be indicated by slower tempo and reduced harmonic brightness; and joy may be indicated by major tonal structures, consonant harmony, and upward melodic movement. In image embodiments, color saturation, hue temperature, spatial openness, object symbolism, and contrast ratios may be algorithmically selected.

As illustrated in FIG. 2B, behavioral interaction metrics 254a-254f include: mouse clicking behavior 254a, which captures click frequency, click pressure where hardware-supported, and inter-click timing patterns; mouse and cursor movement behavior 254b, which captures cursor acceleration, deceleration, trajectory, and hesitation intervals; keyboard input 254c, which captures keystroke latency, inter-key timing intervals, error-correction frequency, and dwell time per key; eye movement data 254d, which captures gaze-tracking vectors, fixation duration, saccadic velocity, and blink rate where gaze-tracking hardware is present; speech pattern data 254e, which captures pitch variance, speech rate, pause frequency, and harmonic spectral content from audio input; and mouth movement data 254f, which captures geometric changes in lip and jaw position detectable from video input. These six categories of behavioral metrics collectively form the behavior profile 252 of the subject, which is used as input to the behavioral biometrics module 610 further described in connection with FIG. 6.

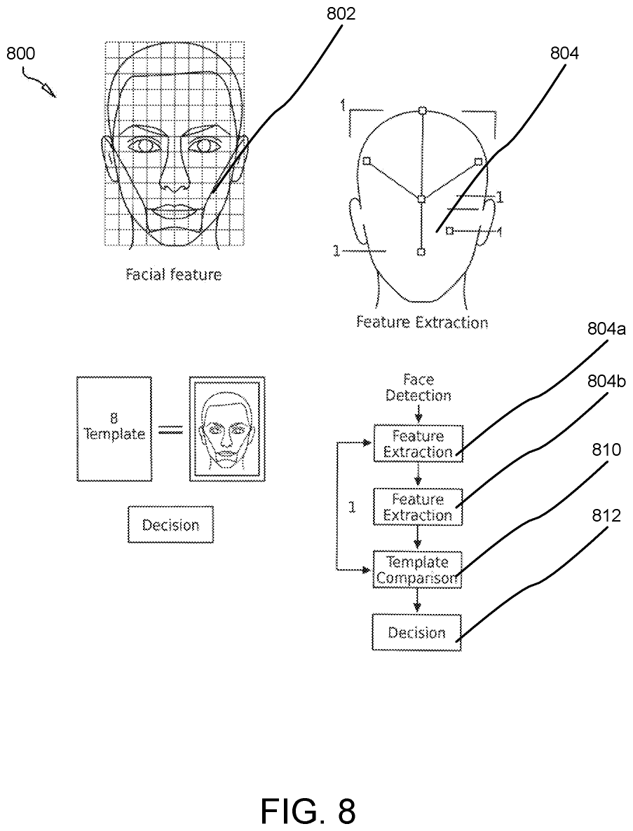

The behavioral biometrics module 610, as illustrated in FIG. 2B, applies machine learning classifiers to the behavioral profile 252 to determine whether any of the measured behavioral metrics deviate from a normative pattern of behavior established for the subject 102. The normative pattern may be derived from the subject's own prior interaction data, from population-level behavioral norms, or from a combination of both. Detection of behavioral anomalies constitutes an additional independent channel for emotional state evaluation, supplementing the facial and vocal biometric analysis described in connection with FIGS. 1 and 8. Extracting biometric feature data may comprise this behavioral biometric analysis, incorporating at least one of keystroke latency, cursor movement patterns, click frequency, gaze tracking vectors, or user interaction hesitation intervals.

As shown in FIG. 2B, behavioral biometrics 254a-254f may include: cursor acceleration patterns, click pressure (where supported), keystroke latency, hesitation intervals, scroll velocity, and/or gaze-tracking vectors.

The behavioral biometrics module 610 may utilize anomaly detection and supervised machine learning classifiers to correlate behavioral signatures with emotive states.

Upon determining a predominant emotional vector, the rendering module 604 generates media 106. In music embodiments: tempo, key signature, harmonic complexity, dissonance level, rhythmic density, instrument timbre may be modulated in response to emotional intensity. For example: high anger intensity may indicate increased tempo, distorted timbre, minor tonal center. Depression may be indicated by slower tempo, reduced harmonic brightness. Joy may be indicated by major tonal structures, consonant harmony, upward melodic movement.

In image embodiments: color saturation, hue temperature, spatial openness, object symbolism, contrast ratios may be algorithmically selected.

FIG. 2C is a diagram 270 exemplifying a comparative analysis algorithm configured to evaluate an emotive state from behavior biometrics and produce media in response in accordance with the present invention.

Displayed is a fixed proportion of normally-distributed values falling within a given number of standard deviations from mean. Each value 272 represents, in the shown embodiment, a rapidity of eye movements of a user. In various embodiments,

Standard deviation is traditionally defined as the distance from the mean which contains most datapoints. For normal bell curves, approximately 68% of datapoints fall within the standard deviation (σ), while two standard deviations from the mean will often contain about 95% of the datapoints, and three standard deviations from the mean will often include about 99% of all datapoints per the empirical rule.

When measuring biometrics, such as frequency of eye movement, values tend to be clustered around the mean. For those users whose eye movements exceed a predetermined threshold 274, such 2σ by way of example, an eye movement parameter 282 may be included in an algorithm determining an anxiety score 284, such as that shown in FIG. 2D.

In some embodiments, the technology provider first determines if one or more of the following behaviors fall outside a normative pattern of behavior: cursor acceleration patterns, click pressure, keystroke latency, hesitation intervals, scroll velocity, and/or gaze-tracking vectors. These behaviors may be determined to fall outside a normative pattern of behavior if the measured behaviors over a predetermined period of time, such as 20 seconds or less, exceed one or two standard deviations.

The result of this statistical evaluation determines whether a given behavioral parameter contributes an elevated value to the anxiety score Ax or anger score Ag computations described below. This statistical processing supports the emotional score computation, wherein a plurality of biometric parameters including eye movement measurements, keyboard interaction metrics, and speech pattern metrics are used to determine the emotional state of the subject.

FIG. 2D illustrates an exemplary algorithm 280 for calculating an anxiety score (Ax) in accordance with the present invention.

The anxiety score Ax 284 is expressed by the formula: Ax=EM*KC*SP, wherein EM 282 represents an eye movement parameter, KC 286 represents a key-click measurement parameter, and SP 288 represents a speech pattern parameter. Each of these input variables is derived from real-time biometric measurements of the subject 102, as further described herein.

The eye movement parameter EM 282 may be derived from saccadic motion frequency, blink rate, gaze fixation duration, or pupil dilation measurements captured from video input. Elevated or erratic eye movement relative to a neutral baseline specimen 432 may indicate heightened anxious arousal.

The key-click measurement parameter KC 286 may be derived from keystroke latency, inter-key timing intervals, error rate, or hesitation patterns detected during user interaction with a keyboard or touchscreen. Irregular or accelerated keystroke cadence beyond a normative threshold may indicate elevated anxiety levels in the subject 102.

The speech pattern parameter SP 288 is defined as fluctuations in intonation between words or syllables, fluctuations in pitch, or a quantification of the degree to which speech is speeding up or slowing down relative to a base speed determined from neutral models. Elevated speech rate, increased pitch variance, or reduced pause frequency may each contribute to a higher SP 288 value, thereby increasing the computed anxiety score Ax 284.

In various embodiments, each input parameter EM 282, KC 286, and SP 288 may be normalized against the subject's own neutral baseline specimens 432 prior to computation, such that the resulting anxiety score Ax 284 reflects deviation from the subject's personal norm rather than a population-wide average. The anxiety score Ax 284 may be used as an input to the rendering module 604 to modulate parameters of the output media 106, such as tempo, dissonance, or color saturation, in proportion to the detected anxiety level.

For instance, a high anxiety score may produce output music with elevated tempo, increased harmonic dissonance, and compressed rhythmic patterns, while a lower anxiety score near baseline may produce more harmonically stable and rhythmically regular output. This direct parametric mapping between the anxiety score and media generation parameters provides a quantitative, reproducible relationship between the subject's detected emotional state and the characteristics of the responsive media.

FIG. 2E illustrates an exemplary algorithm 290 for calculating an anger score (Ag) in accordance with the present invention.

The anger score Ag 294 is expressed by the formula: Ag=EM*KL*MM, wherein EM 282 represents an eye movement parameter, KL 296 represents a key latency measurement parameter, and MM 298 represents a mouth measurement parameter. As with the anxiety score described above in connection with FIG. 2D, each input variable is derived from real-time biometric measurements of the subject 102 and compared against stored neutral baseline specimens 432.

The eye movement parameter EM 282 in the anger score algorithm 290 may reflect a different characteristic pattern than in the anxiety score. In anger states, eye movement may be characterized by reduced blink frequency, narrowed gaze, increased fixation duration on specific targets, or pronounced lateral eye movement. These patterns, when detected as deviating from the subject's neutral baseline, may elevate the EM 282 value in the anger computation.

The key latency parameter KL 296 may reflect the force, speed, or duration of individual keystrokes. In anger states, subjects may exhibit increased keystroke force (where supported by hardware), decreased inter-key intervals, or a higher proportion of error-correction keystrokes. These deviations from a normative keystroke pattern may be quantified as the KL 296 value and factored into the anger score Ag 294.

In anger states, subjects typically exhibit increased keystroke force where supported by pressure-sensitive hardware, decreased inter-key intervals reflecting more forceful and rapid typing, and a higher proportion of error-correction keystrokes reflecting less careful interaction with the input device. These deviations are quantified as the KL 296 value and incorporated into the anger score formula.

The mouth measurement parameter MM 298 may be derived from geometric analysis of the subject's facial features, including the distance between the corners of the mouth and reference points such as the nose or the bottom of an eye. In anger states, characteristic mouth positions may include tightened lips, downward curvature of the mouth corners, jaw clenching, or compressed lip geometry relative to neutral facial configurations. These geometric deviations are quantified by the AI engine 414 using the facial feature extraction process described in connection with FIG. 8, and contribute to the mouth measurement MM 298.

In various embodiments, the anger score Ag 294 and the anxiety score Ax 284 may be computed concurrently, enabling the system to distinguish between overlapping emotional states that share common biometric indicators. For example, both anxiety and anger may produce elevated eye movement scores EM 282; however, differences in the KL 296 versus KC 286 parameters and the MM 298 parameter may allow the system to differentiate between the two states and generate appropriately targeted output media 106.

The concurrent computation of both the anxiety score Ax 284 and the anger score Ag 294 enables the system to resolve ambiguous emotional states in which multiple overlapping biometric signals are present simultaneously. For example, both anxiety and anger may produce elevated eye movement values EM 282; however, the distinction between the KC 286 parameter used in the anxiety formula and the KL 296 parameter used in the anger formula, combined with the presence or absence of a significant MM 298 value from facial geometry analysis, allows the system to differentiate between these states and generate appropriately targeted output media 106. The distinct parametric formulas therefore enable the system to produce granular, emotion-specific media rather than generic responses to arousal levels alone.

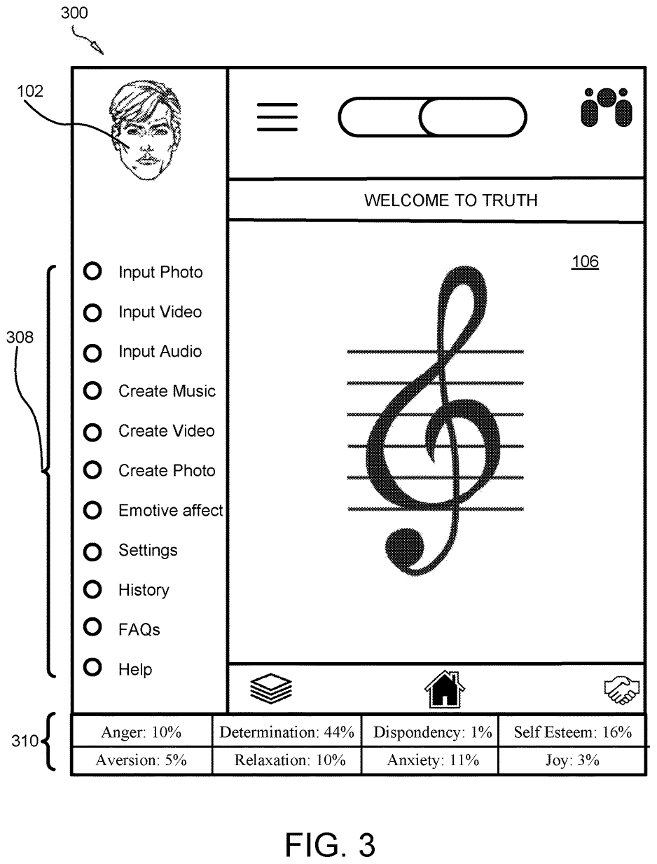

FIG. 3 is an illustrative browser displaying an exemplary interface 300 adapted to facilitate analysis of an emotional state and rendering media exclusively associated with the individual and emotional state in accordance with the present invention.

In the exemplary dashboard 300, a subject (i.e. user) 102 may make selections from virtual controls 308, including selecting to input a photo of the subject 102, a video, audio or the like. The user 102 may also prompt the technology provider to create, using AI, output media 106 such as music from recently uploaded media 202. In other embodiments, the output media 106 comprises images, video or text.

By way of example, the output media 106 may comprise an illustration determined to correspond with the emotive state determined, such as a sunset with may correspond with feeling of contentment, whereas a sports car may correspond with feelings of excitement. Color schemes may be used in the output media which likewise correspond to emotive states, such as subdued colors for depressed states and bright colors for happy or excited states. By way of example, a brightly colored sports car may be output as part of the output media 106 for a happy state.

In some embodiments, not only is the media 106 generated, but emotive feelings are evaluated independently from the media 202 to create a spectrum or measurements 310 of the degree to which the user 102 is expressing different emotive states as shown. The emotional vector 227 may comprise the measurements 310.

The system 300-600 may monitor subject response to output media 106a/106b. Subsequent biometric measurements may determine whether: negative emotional intensity decreases, positive emotional intensity increases, or emotional neutrality is restored.

Response data is stored in persistent storage 428 and may be correlated with media parameters to form individualized emotional modulation profiles.

As further illustrated in FIG. 3, the interface 300 displays a real-time emotional measurement panel 310 at the base of the dashboard. Panel 310 shows a spectrum of evaluated emotional states and their respective intensity percentages, for example: Anger 10%, Determination 44%, Despondency 1%, Self Esteem 16%, Aversion 5%, Relaxation 10%, Anxiety 11%, and Joy 3%. This display corresponds to the multidimensional emotional vector, providing a visual representation of the probability score and intensity scalar value assigned to each detected emotion. The simultaneously displayed values across eight emotional dimensions confirm that the system does not produce a single-label classification but rather a multidimensional representation of the subject's emotional condition at the time of evaluation.

The main content area of the interface 300 displays the currently generated output media 106, which in the illustrated embodiment comprises a treble clef notation element representative of an original musical composition. The interface 300 is configured to deliver the generated digital media to the human subject via a computer, and supports the subject's interaction with the output media through the same device used to capture input media 202. The emotional measurement panel 310 is updated in response to new biometric measurements captured after presentation of the output media, reflecting the closed-loop feedback architecture wherein updated biometric feature data is captured after presentation and used to modify media generation parameters.

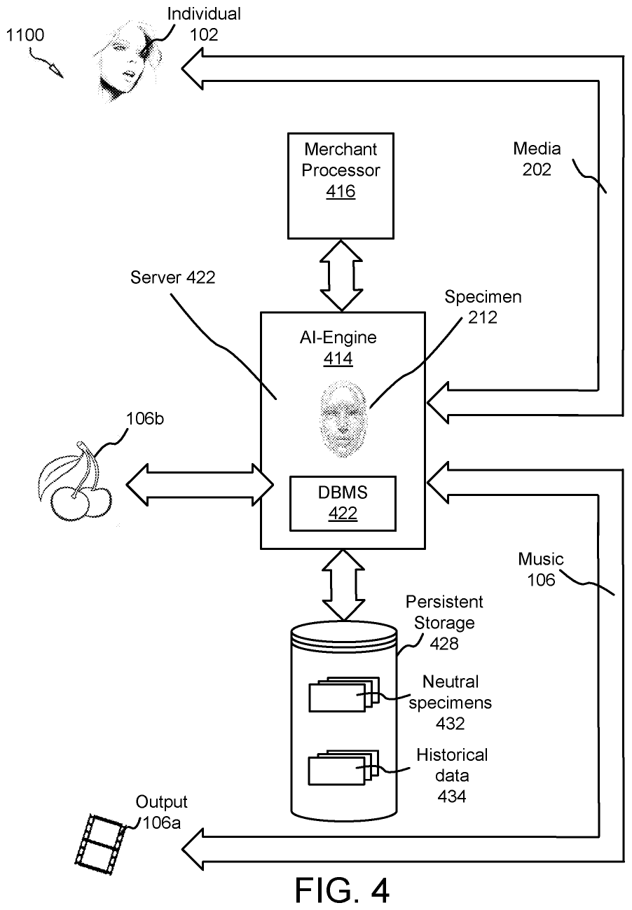

FIG. 4 is a data-entity diagram of an exemplary method of generating emotive media, in accordance with the present invention.

The user 102 may choose whether the AI engine 414 generated an image 106b or music 106a as output. A DBMS or RDBMS works with the AI. The AI may comprise an external system to which information, including the media 202, is relayed. In various embodiments, the specimen 212 is stored in persistent storage 428 by the technology provider or a third-party AI provider.

The AI engine 414 updates model weights using reinforcement learning techniques wherein: successful emotional modulation results in reward signals; unsuccessful modulation reduces weighting for corresponding media parameters.

Over time, output media becomes uniquely optimized for the specific subject.

The persistent storage 428 may include neutral specimens 432 and historical data of previous outputs 106 and media 202 sent by the user 102 to the technology provider.

FIG. 4 is a data-entity and system architecture diagram 1100 illustrating an embodiment of the AI-driven emotive evaluation and media generation environment in accordance with the present invention.

As shown, a subject or individual 102 provides input media 202 to a processing environment that includes an AI engine 414, a database management system (DBMS) 422, and persistent storage 428. The components may be hosted on a server 422 operated by a technology provider or third-party service.

The input media 202 may comprise image data, video data, audio recordings, textual input, or combinations thereof. In certain embodiments, the media 202 is captured on a user device and transmitted via a network to the server 422 for processing.

The AI engine 414 is configured to process the media 202 to determine an emotive state of the individual 102. The AI engine 414 may include one or more machine learning models trained to evaluate biometric features, behavioral signals, or sentiment indicators extracted from the media 202.

The DBMS 422 is operatively coupled to persistent storage 428 and stores structured data relating to: specimens 212, historical data 434, previously generated output media 106, and user-specific emotional response correlations.

The specimens 212 stored in persistent storage 428 may include neutral specimens 432 representing baseline emotional states of the individual 102. In some embodiments, additional specimens represent known emotive conditions such as joy, anger, anxiety, depression, relaxation, or determination.

The AI engine 414 compares extracted biometric data from the current media 202 to the stored specimens 212 using a comparative analysis algorithm. Based on this comparison, the AI engine 414 determines one or more emotions being experienced by the individual 102 and may assign corresponding intensity values.

The AI engine 414 is further configured to generate output media 106 responsive to the determined emotional state. In certain embodiments, output media 106a comprises music generated by the AI engine 414, while output media 106b comprises visual content such as images or video.

The generated output media 106 is transmitted to the individual 102 for presentation. In some embodiments, the system monitors subsequent reactions of the individual 102 to the output media and records additional biometric or behavioral data.

Historical data 434 stored in persistent storage 428 may include prior emotional determinations, previously generated output media 106, response effectiveness metrics, timestamps, and adaptive parameter adjustments. This historical data 434 enables iterative refinement of future media generation and personalization of emotional modulation.

In certain embodiments, a merchant processor 416 may be operatively connected to the system 1100 to facilitate subscription management, transactional billing, or licensing of generated media. The merchant processor 416 may interface with the server 422 while remaining logically separate from the AI engine 414.

Accordingly, FIG. 4 illustrates a networked architecture in which multimedia input 202 is processed by an AI engine 414, compared against stored specimens 212 and historical data 434 within a DBMS 422 and persistent storage 428, and used to generate responsive output media 106 tailored to the individual 102.

The AI engine 414 may be the primary computational component responsible for processing multimedia input 202, extracting biometric feature data, comparing those features to stored specimens 212, determining the emotional state and intensity value of the subject, generating the multidimensional emotional vector, and driving the generation of responsive digital media 106 through the rendering module 604. The AI engine 414 may incorporate one or more machine learning models, generative AI components, and the reinforcement learning agents.

The DBMS 422 is operatively coupled to persistent storage 428 and maintains structured data comprising: specimens 212, including neutral specimens 432 and subject-specific emotive-state exemplars; historical data 434, including prior emotional determinations, previously generated output media, and response effectiveness metrics; and user-specific emotional response correlations. The persistent storage 428 architecture directly supports the limitations, wherein emotional-response correlation data associating detected emotional states, generated media parameters, and measured biometric responses is stored in persistent computer-readable memory and used to personalize subsequent media generation for the subject.

As shown in FIG. 4, the merchant processor 416 is operatively connected to the server 422 to facilitate subscription management, transactional billing, and licensing of generated media. The merchant processor 416 interfaces with the server 422 while remaining logically separate from the AI engine 414, such that commercial transaction processing does not interrupt or interfere with the real-time emotional evaluation and media generation pipeline. Output media 106a, representing generated music, and output media 106b, representing generated images or other visual content, are transmitted from the DBMS 422 and AI engine 414 to the subject 102 for presentation.

The reinforcement learning feedback mechanism within the AI engine 414 as shown in FIG. 4. When output media 106 is presented to the subject 102 and updated biometric feature data is subsequently captured, the AI engine 414 evaluates whether the output media produced a desired modulation of the subject's emotional state. Successful emotional modulation generates a reward signal that increases the weighting of the corresponding media generation parameters in the AI engine's model. Unsuccessful modulation reduces the weighting of those parameters. Over successive iterations, this reinforcement learning process causes the AI engine 414 to generate output media that is uniquely optimized for the specific subject 102, as illustrated by the subject-specific historical data 434 maintained in persistent storage 428.

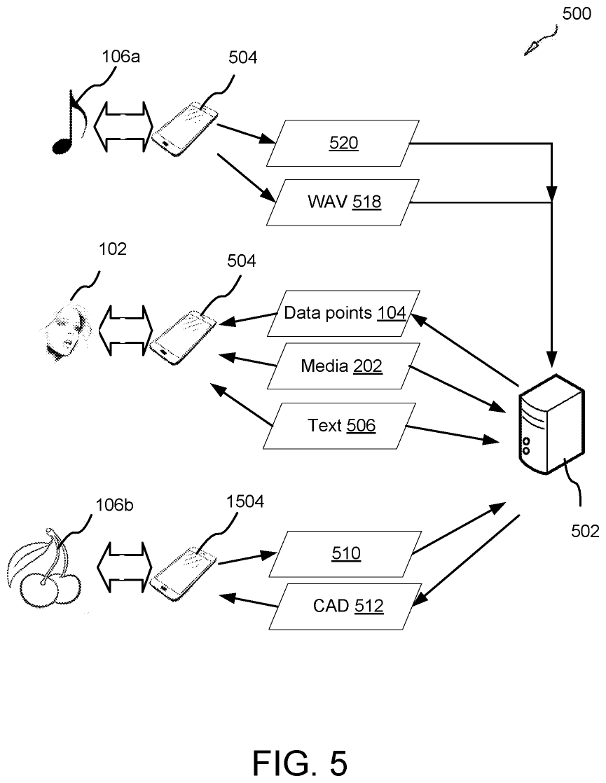

FIG. 5 is a data-entity diagram of an exemplary method of generating emotive AI media in accordance with the present invention.

Data flows to and from the user's 102 mobile phone 504, computer or data processing device (DPD) as shown. The media 202 may comprise text 506 as shown, from which an emotive state may be evaluated.

FIG. 5 is a data-entity diagram 500 illustrating data flow between a user device 504 and the emotion-evaluation and media-generation system in accordance with the present invention.

In the illustrated embodiment, a user 102 interacts with the system using a data processing device (DPD) 504, which may comprise a mobile phone, tablet, laptop computer, desktop computer, or wearable computing device. The device 504 is configured to capture and transmit media 202 to a remote or local AI processing environment. The media 202 may comprise one or more of: image data, video data, audio data, textual input 506, or combinations thereof.

In certain embodiments, the textual input 506 includes user-generated narrative statements describing emotional condition, journal entries, chat interactions, or social media-style postings.

The device 504 may encode the media 202 into standardized digital formats including MPEG-based video formats, MP3 or WAV audio formats 518, JPEG or PNG image formats, or structured text encodings. The encoded media is transmitted over a network to the AI evaluation system.

The diagram further illustrates data points 104 extracted from the media 202. These data points 104 may include geometric facial measurements, acoustic frequency measurements, lexical sentiment markers, or behavioral timing signals derived from user interaction.

In some embodiments, the system may generate output media 106a and 106b and return such output to the user device 504. Output media 106a may comprise generated audio (e.g., music in WAV 518 or MP3 format), while output media 106b may comprise generated images, video, or CAD-based renderings 512.

The diagram further illustrates bidirectional communication 510 between the user device 504 and the processing system. This bidirectional exchange may enables: transmission of input media 202, delivery of generated output media 106, receipt of user interaction data, and transmission of updated emotional-response data.

In certain embodiments, the device 504 may temporarily cache media locally before upload, may perform preliminary preprocessing such as compression or feature extraction, or may execute lightweight inference models prior to full AI processing.

The data-entity relationships illustrated in FIG. 5 demonstrate how raw media 202 is transformed into structured data points 104, processed by AI algorithms, and rendered into responsive output media 106, thereby forming part of the closed-loop emotional modulation system described herein.

As illustrated in FIG. 5, the input media 202 transmitted from the DPD 504 to the AI server 502 comprises data points 104 extracted from the subject, media 202 including image and video content, and text 506, which may include narrative statements, journal entries, or other user-generated textual content. Text 506 is among the forms of multimedia input and may be subjected to lexical sentiment analysis as one form of biometric feature extraction. The data points 104 illustrated in FIG. 5 represent the extracted biometric feature data, encompassing facial landmark measurements, vocal acoustic features, lexical sentiment indicators, and behavioral interaction metrics.

Output media 106a transmitted from the server 502 to the first output device comprises generated audio in WAV 518 or other audio formats. Output media 106b transmitted from the server 502 to the second output device 1504 comprises generated images, video, or CAD-based renderings 512, wherein generated digital media may comprise an image or video having visual parameters selected based on the emotional state. The bidirectional communication 510 shown in FIG. 5 enables not only delivery of output media to the subject but also transmission of updated biometric or behavioral response data back to the server 502, supporting the closed-loop feedback architecture.

FIG. 6 is a block diagram illustrating one embodiment of a system 600 configured to evaluate an emotive state of a subject 102 and generate responsive AI media 106 in accordance with the present invention.

As shown, an image 106b, photo or other media 202 may be input into the system. The system 600 may comprise a rendering module 604 for rending an output 106 in CAD format, such as STP. Alternatively the output 106 may be in JPG, PNG, MP3, MP4, or WAV formats, or other formats known to those of skill in the art.

The system 600 may comprise additional modules 608-618 for generating the output 106 and processing the input media 202, including algorithms relating to music theory. The system may comprise a behavior biometric module 610 configured to analyze behavior biometrics as described above.

The system 600 comprises a measuring module 602, a rendering module 604, a comparative analysis module 606, a behavioral biometrics module 610, and one or more auxiliary processing modules 608, 612, 614, 616, and 618. The system 600 is operatively coupled to a relational database management system (RDBMS) 422 and computer-readable storage media.

The measuring module 602 may be configured to receive input media 202, which may include a photo, image 106b, video 632, audio file, or text input. The measuring module 602 extracts quantifiable biometric and expressive features from the input media, including facial landmarks, geometric distances between facial features, curvature measurements, micro-expression timing, vocal pitch variation, lexical sentiment indicators, and temporal behavioral signals.

The comparative analysis module 606 is configured to compare extracted biometric data against stored specimens 212. The specimens 212 may include neutral baseline specimens, previously recorded emotive-state specimens of the same subject 102, and generalized emotive datasets derived from a broader population. The comparative module 606 may generate one or more emotional probability scores and may produce a multidimensional emotional state vector representing intensity, polarity, and persistence of detected emotions.

The specimens 212 may include neutral baseline specimens of the same subject 102, subject-specific emotive-state exemplars, and generalized emotive datasets from a broader population. The comparative analysis module 606 generates one or more emotional probability scores and produces a multidimensional emotional state vector representing the intensity, polarity, and temporal persistence of detected emotions.

The behavioral biometrics module 610 is configured to analyze user interaction data 608, 612, including cursor movements, keystroke timing, scroll velocity, dwell time, gaze tracking, touchscreen pressure, and interaction hesitation intervals. The behavioral biometrics module 610 may operate concurrently with the measuring module 602 and may supplement or refine emotional state determinations generated by the comparative analysis module 606.

The outputs of the behavioral biometrics module 610 supplement or refine the emotional state determinations generated by the comparative analysis module 606, and contribute to the emotional scores computed per the formulas of FIGS. 2D and 2E.

In certain embodiments, modules 614, 616, and 618 comprise machine learning components including neural networks, reinforcement learning agents, sentiment classifiers, or generative adversarial networks (GANs). These modules refine emotional classification accuracy and optimize media generation parameters over time based on historical response data stored in the RDBMS 422.

The rendering module 604 may be configured to generate output media 106a, 106b responsive to the determined emotional state. In music-generation embodiments, the rendering module 604 produces audio output 106a in formats such as MP3, WAV 518, or other digital audio formats, with compositional parameters selected based on emotional intensity and polarity. In image or video embodiments, the rendering module 604 generates visual output 106b in formats such as JPG, PNG, MP4, or CAD-based renderings.

Auxiliary modules 614, 616, and 618 illustrated in FIG. 6 comprise machine learning components including neural networks, reinforcement learning agents, sentiment classifiers, and generative adversarial networks (GANs). These modules are responsible for refining emotional classification accuracy over time and for optimizing media generation parameters based on historical response data stored in the RDBMS 422. The reinforcement learning agents among these modules implement the parameter modification step, wherein media generation parameters of the generative AI engine are updated based on measured emotional response to the generated digital media, with successful modulation generating reward signals and unsuccessful modulation reducing parameter weighting.

The rendering module 604 receives the multidimensional emotional vector from the comparative analysis module 606 and the emotional scores from the behavioral biometrics module 610 and generates output media 106a and 106b responsive to the determined emotional state. For music-generation embodiments, the rendering module 604 modulates at least one of: tempo, harmonic structure, rhythmic density, tonal center, or instrument timbre based on the determined emotional state and intensity value. Specifically, high-anger states characterized by elevated Ag scores drive output compositions with increased tempo, distorted or percussive timbre, and minor tonal centers; depression states drive slower tempos and harmonically darker tonalities; and joy states drive major tonal structures, consonant harmony, and upward melodic contour. For image and video embodiments, the rendering module 604 selects visual parameters including color palette, color saturation, hue temperature, spatial openness, and contrast levels based on the emotional state and intensity value.

The system 600 may further include a feedback loop wherein newly generated output media 106 is presented to the subject 102 and subsequent biometric measurements are captured to determine whether the output media successfully modulated the emotional state. Updated emotional-response data is stored in the RDBMS 422 for iterative training and personalization.

In some embodiments, the system 600 operates in a distributed architecture, wherein one or more modules execute on a remote server environment while input capture occurs on a user device such as a smartphone 504 or other data processing device. In alternative embodiments, the modules operate locally on an edge device.

Accordingly, FIG. 6 illustrates a modular, adaptive, closed-loop system architecture capable of evaluating emotive state using multimodal biometric and behavioral inputs and generating responsive AI-created media tailored to the subject.

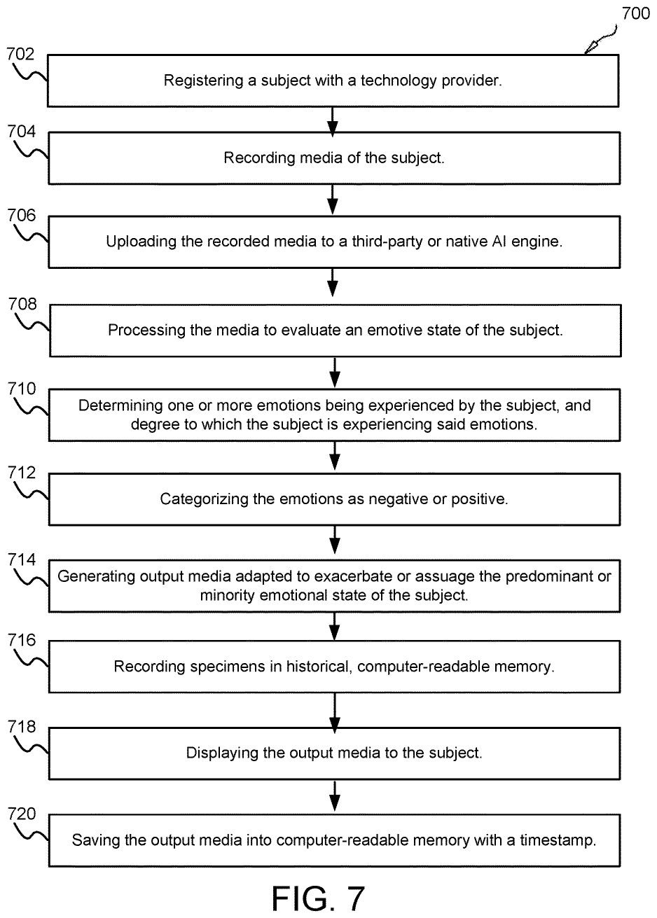

FIG. 7 is a flow chart illustrating one embodiment of a method 700 and system for AI-generated evaluation of emotive state and responsive media generation in accordance with the present invention.

Beginning at step 702, a subject is registered with the technology provider, during which neutral baseline biometric specimens 432 are recorded and stored in persistent storage 428. These neutral baseline specimens serve as the stored reference specimens and specifically as the neutral baseline biometric specimens of the same human subject captured during a previously recorded neutral emotional state. Recording baseline specimens in a controlled neutral condition prior to operational use ensures that subsequent emotional state determinations reflect genuine deviations from the subject's personal norm rather than population-level averages.

At step 704, media of the subject is recorded, comprising one or more of video, audio, photograph, or text as recited. At step 706, the recorded media is uploaded via a wide-area network (WAN) to the technology provider's AI processing environment. Steps 704 and 706 together implement the step of receiving multimedia input associated with the human subject. At step 708, the media is processed to evaluate the emotive state of the subject, implementing the biometric feature extraction and comparative analysis steps. At step 710, the system determines one or more emotions being experienced by the subject and the degree to which those emotions are present, implementing the emotional state and intensity value determination and the multidimensional emotional vector generation.

At step 712, the detected emotions are categorized as positive or negative. Negative emotions include anger, depression, horror, apathy, disgust, and anxiety; positive emotions include joy, relaxation, and determination. This categorization informs the directionality of the generated media: for negative emotional states, the system may generate media adapted to assuage or reduce the intensity of those states; for positive emotional states, the system may generate media adapted to reinforce or amplify those states. At step 714, output media is generated responsive to the categorized emotional state, implementing the media generation step as further specified.

At step 716, emotive specimens are recorded in historical computer-readable memory, implementing the persistent storage limitation. At step 718, the output media is displayed to the subject, implementing the presentation step. The presentation of output media is accompanied by continued biometric monitoring of the subject, implementing the updated biometric feature data capture step. At step 720, the output media is saved in computer-readable memory with a timestamp, forming part of the historical data 434 that is used to personalize subsequent media generation for the subject as recited.

FIG. 8 is a data entity diagram illustrating one embodiment of a method and system for AI-generated evaluation of emotive state and responsive media generation in accordance with the present invention;

As shown in FIG. 8, the facial recognition and feature extraction process begins with the detection of a facial feature region 802 within input media 202. The system identifies the presence of a human face within the image or video frame and isolates the facial region for further analysis. This detection step may utilize known face-detection algorithms, including cascade classifiers, convolutional neural networks, or other detection methodologies known to those of skill in the art.

Once the facial region is detected, the system proceeds to feature extraction 804. As illustrated, feature extraction 804 involves mapping a grid or mesh overlay 802 onto the subject's face to identify and localize anatomical landmarks including the corners of the eyes, the bridge of the nose, the corners and center of the mouth, the chin, and the outer and inner edges of the eyebrows. These landmarks define a set of reference data points 104 used for subsequent geometric measurement and comparative analysis.

In the embodiment shown, the feature extraction process 804 is further subdivided into a first feature extraction pass 804a and a second feature extraction pass 804b. The first pass 804a may perform a coarse landmark localization across the full facial region, establishing primary reference points. The second pass 804b may perform a refined extraction focused on regions of particular emotional significance, such as the periorbital area surrounding the eyes, the perioral area surrounding the mouth, and the corrugator and frontalis muscle regions of the brow. This multi-pass approach improves the accuracy of geometric measurements used in emotional scoring.

The feature extraction process 804 is subdivided into a first feature extraction pass 804a and a second feature extraction pass 804b. The first pass 804a performs a coarse landmark localization across the full facial region, establishing primary reference points used to orient subsequent measurements. The second pass 804b performs a refined extraction focused on regions of particular emotional significance, including the periorbital area surrounding the eyes, the perioral area surrounding the mouth, and the corrugator and frontalis muscle regions of the brow. The secondary refined extraction pass 804b is particularly relevant to the computation of the mouth measurement parameter MM 298 used in the anger score Ag formula of FIG. 2E, as the precise geometric measurements of lip curvature, mouth-corner displacement, and inter-lip distance required for MM 298 benefit from the higher-resolution localization provided by the second extraction pass.

Following feature extraction, the extracted data points are submitted to a template comparison step 810. In this step, the system compares the extracted facial geometry against one or more stored templates 812 representing neutral or emotively-categorized facial configurations of the subject 102. As shown, the template store may include multiple templates representing a range of known emotional states, alongside a neutral baseline template derived from neutral specimens 432 previously recorded for the subject 102.

The template comparison step 812 computes geometric distances and angular relationships between the extracted data points 104 and the corresponding reference points in each stored template, including measurements such as the distance between the corners of the mouth and the outer corners of the eyes, the vertical height of the eye aperture, the curvature of the upper lip, the degree of eyebrow elevation or depression, and the separation between the inner eyebrow edges.

The template comparison 812 computes geometric distances and angular relationships between the extracted data points 104 and the corresponding reference points in each stored template. Distances may include measurements such as the distance between the corners of the mouth and the outer corners of the eyes, the vertical height of the eye aperture, the curvature of the upper lip, the degree of eyebrow elevation or depression, and the separation between the inner eyebrow edges. These measurements collectively define a facial geometry vector that is compared against template vectors to determine the closest matching emotional state.

A decision 812 is rendered by the AI engine 414 based on the result of the template comparison. The decision may comprise one or more emotional state classifications with associated probability scores, as well as specific measurement outputs such as the mouth measurement MM 298 used in computing the anger score Ag 294 described above in connection with FIG. 2E. The decision output feeds into the comparative analysis module 606 and rendering module 604 to drive generation of responsive output media 106.

The output of the template comparison step 812 is a decision rendered by the AI engine 414 comprising one or more emotional state classifications with associated probability scores. This decision output includes the specific geometric measurement values—including the mouth measurement MM 298—that feed into the emotional scoring formulas of FIGS. 2D and 2E and are passed to the comparative analysis module 606 and rendering module 604 to drive generation of responsive output media 106. For video input, the facial feature extraction and template comparison process is performed on a frame-by-frame basis, enabling temporal tracking of emotional state changes over the duration of the recording and producing a time-series of emotional state decisions stored as historical data 434 in persistent storage 428.

In various embodiments, the facial feature extraction and template comparison processes described in FIG. 8 are performed on a frame-by-frame basis for video input, enabling temporal tracking of emotional state changes over the duration of the recording. The resulting time-series of emotional state decisions may be stored as historical data 434 in persistent storage 428 for use in longitudinal emotional profiling and iterative refinement of output media generation.

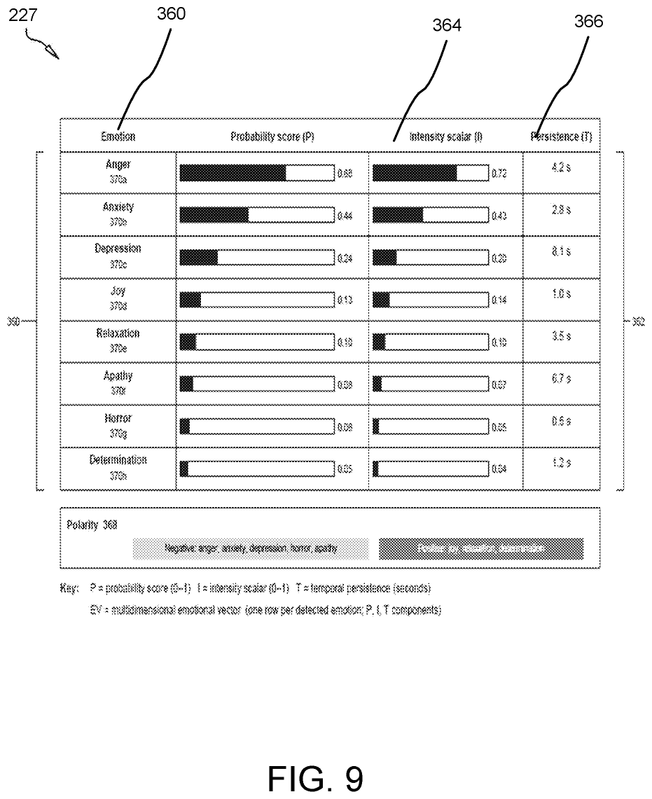

FIG. 9 is a diagram illustrating the structure of a multidimensional emotional vector 227 in accordance with the present invention.

As shown, the emotional vector 227 is embodied as a vector array 352 organized as a table comprising one row 370a-370h for each emotional state evaluated by the comparative analysis module 606. In the illustrated embodiment, eight emotional states are represented: anger 370a, anxiety 370b, depression 370c, joy 370d, relaxation 370e, apathy 370f, horror 370g, and determination 370h. The vector array 352 comprises four columns for each row: an emotion label column 360, a probability score column 362, an intensity scalar column 364, and a temporal persistence column 366.

The emotion column 360 identifies the emotional state corresponding to each row 370a-370h of the vector array 352. The probability score column 362 contains a scalar value in the range [0, 1] representing the likelihood that the subject 102 is experiencing the corresponding emotional state, as determined by the comparative analysis module 606 through comparison of the extracted biometric feature data against the stored reference specimens 212. A probability score of 1.0 indicates complete confidence that the emotional state is present; a score of 0.0 indicates that the state was not detected. In the exemplary vector 350 illustrated in FIG. 2F, anger 370a has a probability score of 0.68, indicating that the comparative analysis module 606 has determined with 68% confidence that the subject 102 is experiencing anger at the time of evaluation.

The intensity scalar column 364 contains a scalar value in the range [0, 1] representing the degree or strength with which the subject 102 is experiencing each detected emotional state. The intensity scalar 364 is distinct from the probability score 362: the probability score 362 indicates the likelihood that an emotion is present, while the intensity scalar 364 quantifies how strongly that emotion is manifested in the subject's biometric data relative to the subject's stored neutral baseline specimens 432. An intensity scalar of 1.0 represents maximum detected intensity relative to the subject's personal baseline; a value of 0.0 indicates no detectable intensity above baseline. The intensity scalar 364 is used by the rendering module 604 as a primary input for modulating media generation parameters, including tempo, harmonic complexity, color saturation, and contrast level, in proportion to the strength of the detected emotional state. As recited in claim 1, the emotional vector represents both the polarity and intensity of the emotional state; the intensity scalar column 364 is the component of the vector that carries the intensity information used to drive parametric media generation.

The temporal persistence column 366 contains a value, expressed in seconds, representing the duration for which each emotional state has been continuously detected in the subject 102 at or above a detection threshold. Temporal persistence 366 provides the rendering module 604 with information about whether a detected emotional state is transient or sustained. A brief transient spike in an emotional state, such as a momentary expression of surprise, may be assigned a low temporal persistence value 366 and may not trigger a full media generation response. A sustained emotional state with a high temporal persistence value 366, such as a prolonged period of detected anxiety or depression, may trigger a more substantial media generation response with greater modulation of media parameters. In the exemplary vector 350 illustrated in FIG. 2F, depression 370c has a temporal persistence value of 8.1 seconds, indicating that the depression state has been continuously detected for 8.1 seconds, the longest persistence among the detected states in the illustrated example. This three-component structure—probability score 362, intensity scalar 364, and temporal persistence 366—collectively constitutes the multidimensional emotional vector 350 recited in claim 1.

As further illustrated in FIG. 9, each emotional state in the vector array 352 is assigned a polarity classification 368 designating the emotional state as either positive or negative. As shown in the polarity legend at the base of FIG. 9, negative emotional states include anger 370a, anxiety 370b, depression 370c, horror 370g, and apathy 370f. Positive emotional states include joy 370d, relaxation 370e, and determination 370h. The polarity classification 368 is used by the rendering module 604 to determine the directionality of the generated media response: for a subject 102 whose vector 350 is dominated by negative-polarity emotional states of high intensity, the rendering module 604 may generate media adapted to assuage or reduce those states; for a subject whose vector 350 is dominated by positive-polarity emotional states, the rendering module 604 may generate media adapted to reinforce or amplify those states. The combined use of probability score 362, intensity scalar 364, temporal persistence 366, and polarity classification 368 provides the rendering module 604 with a precise, quantitative representation of the subject's emotional condition from which individualized media generation parameters can be derived.

The emotional vector 227 illustrated in FIG. 9 is generated by the comparative analysis module 606 upon completion of biometric feature extraction by the measuring module 602, as described in connection with FIGS. 1, 2A, and 8. The vector 227 is passed as a structured input to the rendering module 604, which maps the vector components to specific media generation parameters as described in connection with FIG. 6. The vector 227 is also stored as part of the historical data 434 in persistent storage 428, enabling longitudinal tracking of the subject's emotional profile over time and supporting the iterative personalization of media generation described in connection with claim 10. In video embodiments, a new emotional vector 227 (also labeled as 350) is generated on a frame-by-frame basis, producing a time-series of vector states that enables the system to track the trajectory of the subject's emotional condition across the duration of the recording and to detect trends such as increasing anxiety intensity or decreasing anger persistence in response to presented output media 106.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer-implemented method for adaptive emotional modulation of a human subject, the method comprising:
receiving, at one or more processors, multimedia input associated with a human subject, the multimedia input comprising at least one of: video, audio, text and a photograph;
extracting biometric feature data from the multimedia input, the biometric feature data including at least one of: facial landmark measurements, vocal acoustic features, lexical sentiment indicators, and behavior interacionts metrics;
comparing the biometric feature data to one or more stored reference specimens maintained in computer-readable memory;
determining, using at least one marchine learning model, an emotional state of the human subject and an associated intensity value;
determining, using at least one machine learning model, an emotional state of the human subject and an associated intensity value;
generating a multidimensional emotional vector representing polarity and intensity of the emotional state;
generating, using a generative artificial intelligence engine, digital media responsive to the emotional vector;
presenting the generated digital media to the human subject via a computer;
capturing updated biometric feature data of the subject after presentation of the digital media; and
modifying one or more media generation parameters based on the updated biometric feature data.

2. The method of claim 1, wherein extracting biometric feature data comprises identifying facial landmarks and calculating geometric distances between at least two of: eye corners, mouth corners, nose bridge, eyebrow edges, and chin landmarks.

3. The method of claim 1, wherein extracting biometric feature data further comprises analyzing at least one of: vocal pitch variance, speech cadence, harmonic spectral content, or pause frequency within speech.

4. The method of claim 1, wherein extracting biometric feature data further comprises behavioral biometric analysis including at least one of: keystroke latency, cursor movement patterns, click frequency, gaze tracking vectors, or user interaction hesitation intervals.

5. The method of claim 1, wherein the stored reference specimens comprise neutral baseline biometric specimens of the same human subject captured during a previously recorded neutral emotional state.

6. The method of claim 1, wherein determining the emotional state further comprises computing an emotional score using a plurality of biometric parameters including eye movement measurements, keyboard interaction metrics, and speech pattern metrics.

7. The method of claim 1, wherein the generated digital media comprises an original musical composition generated by modulating at least one of: tempo, harmonic structure, rhythmic density, tonal center, or instrument timbre based on the determined emotional state and intensity value.

8. The method of claim 1, wherein the generated digital media comprises an image or video having visual parameters selected based on the emotional state including: color palette, color saturation, hue temperature, spatial openness, or contrast level.

9. The method of claim 1, wherein modifying the media generation parameters comprises updating parameters of the generative artificial intelligence engine using reinforcement learning based on measured emotional response to the generated digital media.

10. The method of claim 1 further comprising storing, in persistent computer-readable memory, emotional-response correlation data associating: detected emotional states, generated media parameters, and measured biometric responses of the subject, wherein the stored correlation data is used to personalize subsequent media generation for the subject.
